(19) United States
(12) Patent Application Publication
(10) Pub. No.: US 2018/0121576 A1
(43) Pub. Date: May 3, 2018

(54) NETWORK PLANNING USING MOBILE DATA COLLECTION DEVICES AND MACHINE LEARNING

(71) Applicant: Google Inc., Mountain View, CA (US)

(72) Inventors: John Harold Mosher, San Jose, CA (US); Martin B. Freund, Mountain View, CA (US)

(21) Appl. No.: 15/337,963

(22) Filed: Oct. 28, 2016

(51) Int. Cl. G06F 17/50; G06N 99/00

(52) U.S. Cl. CPC G06F 17/509; G06N 99/005

(57) ABSTRACT

Methods, systems, and apparatus, including computer programs encoded on a computer storage medium, for generating a layout of a utility network. In one aspect, a system includes a set of autonomous mobile data collection devices for deploying to a geographic area to collect data about the geographic area. A data processing apparatus can determine, from the data about the geographic area, physical structures located in the geographic area. The data processing apparatus can generate a three dimensional model that represents the physical structures located in the geographical area and obtain, at least from the data about the geographic area, data describing existing infrastructure on which components of the utility network can be installed. The server can generate, based on the three dimensional model and the data describing the existing infrastructure, a layout of the utility network using a trained network planning model.

### BACKGROUND

Designing a utility network is a very labor and time intensive task, which is often burdened by difficulties associated with outdated and inaccurate data, various physical constraints, and human error. For example, it may be more efficient and cost effective to leverage existing infrastructure, e.g., existing utility poles and antenna structures, for building a new utility network. However, records of this information may be erroneous, outdated, and the actual status of the infrastructure can change from the time the information is compiled and the time the network designer actually begins planning the new utility network. For example, a utility pole that previously had capacity to support components of the new utility network based on the records may no longer have that capacity due to other utility providers adding components to the utility pole. Thus, by the time the new utility network is designed, the infrastructure that is to be used in the design may no longer be available. In addition, errors in the information can lead to unfeasible designs and/or costly verification trips to the site of the new network.

### SUMMARY

This specification describes technologies relating to planning a network (e.g., a utility network) using data collected by mobile data collection devices (e.g., drones) and machine learning techniques.

In general, one innovative aspect of the subject matter described in this specification can be embodied in a system for planning a utility network and that includes a set of autonomous mobile data collection devices for deploying to a geographic area to collect data about the geographic area and a data processing apparatus installed on or in data communication with the autonomous data collection devices. The data processing apparatus can determine, from the data about the geographic area, physical structures located in the geographic area. The data processing apparatus can access address data for the geographic area. The address data can specify physical structures and locations of the physical structures. The data processing apparatus can determine whether physical structures located in the geographic area match physical structures specified in the address data for the geographic area. The data processing apparatus can generate, from the data about the geographic area, a three dimensional model that represents the physical structures located in the geographical area. The three dimensional model can specify deviations in the address data from the data about the geographic area collected from the autonomous mobile data collection devices. The data processing apparatus can obtain, at least from the data about the geographic area, data describing existing infrastructure on which components of the utility network can be installed. The data processing apparatus can generate, based on the three dimensional model and the data describing the existing infrastructure, a layout of the utility network using a trained network planning model. Other embodiments of this aspect include corresponding apparatus, methods, and computer programs, configured to perform the actions of the methods, encoded on computer storage devices.

These and other embodiments can each optionally include one or more of the following features. In some aspects, the autonomous mobile data collection devices include autonomous aerial vehicles. In some aspects, the data processing apparatus can identify, from the data collected by the autonomous mobile data collection devices, a particular physical structure located at a particular location within the geographic area that does not match a corresponding physical structure specified by the address data for the particular location and adjust a navigational plan of the autonomous mobile data collection devices to navigate to the particular physical structure to obtain additional information regarding the particular physical structure.

In some aspects, the network planning model generates the layout of the utility network based one or more objectives for the utility network and weights assigned to each feature of a set of features. The features can include at least one of (i) characteristics of objects located along physical paths along which the network can be routed, (ii) characteristics of clearance to route wires or transmit wireless signals along the physical paths, (iii) data related to existing agreements between an owner of the network and other utility providers or property owners in the geographic area, or (iv) weather data for the geographic area.

In some aspects, the data about the geographic area comprises dimensions of the physical structures located in the geographical area and a map of one or more existing utility networks in the geographic area. In some aspects, the data describing the existing infrastructure includes data identifying one or more utility poles located in the geographic area, including at least one of an owner of the one or more utility poles or components installed on the one or more utility poles.

In some aspects, the data about the geographic area includes data describing one or more buildings located in the geographic area, including dimensions of the one or more buildings, external material of the one or more buildings, or an owner of the one or more buildings. The data processing apparatus can obtain data describing infrastructure located in the geographic area from one or more third party data sources.

Particular embodiments of the subject matter described in this specification can be implemented so as to realize one or more of the following advantages. By using mobile data collection devices and machine learning to design networks, the networks can be designed more accurately and more quickly than techniques that require multiple time and resource intensive data verification iterations. By using data collected by the mobile data collection devices, highly accurate dimensions of physical structures and current conditions of network infrastructure can be obtained quickly and can be used to design a network that takes into account up to date, accurate, and rich data about the area at which the network is to be installed. In addition, the amount of resources used to design the network can be reduced by obtaining accurate and up to date information in a single trip to the area. Moreover, verification of address data can be accomplished autonomously, which in turn ensures that load data for utility planning algorithms is up-to-date.

By using autonomous or semi-autonomous mobile data collection devices (e.g., drones) to identify differences between address data that identifies types of buildings located in the area where the network is to be installed and what is actually located in the area, the areas in which the address data is incorrect can be further investigated by the drones during the data collection process. The autonomous or semi-autonomous mobile data collection devices can collect additional data regarding these buildings without requiring additional costly trips to the area. Computer vision processing techniques can be used to process image data to determine multiple different utility aspects regarding a geographic area. This accurate up to date information obtained by the autonomous or semi-autonomous mobile data collection devices allows a machine learning process that generates a network layout to generate a network layout that is better suited (e.g., more efficient, more durable, and/or having better performance) for the environment and infrastructure that is actually located in the area. In addition, the use of aerial mobile data collection devices allows the network to be designed using line of sight and three dimensional data, which results in better performance of wireless networks designed based on the data.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which a network design system generates a layout of a utility network using mobile data collection devices and machine learning techniques.

FIG. 2 is a flow chart of an example process for training a network planning model to generating a layout of a utility network.

FIG. 3 is a flow chart of an example process for generating a layout of a utility network.

FIG. 4 is a flow chart of an example process for collecting information about a physical structure.

Like reference numbers and designations in the various drawings indicate like elements.

### DETAILED DESCRIPTION

Systems and techniques described herein use mobile data collection devices and machine learning techniques to quickly design utility networks (e.g., data communication networks) with very high accuracy and performance. In general, network planning can include several steps. A utility network designer may obtain address data for a particular geographic area to identify the types of buildings that are in the area, e.g., whether the area includes apartments, single family homes, or commercial properties. The address data may also include utility requirements of the buildings are sub-areas in the geographic area, pole owners, and the like. However, this data can be very inaccurate and outdated, resulting in automated data processing errors, which in turn results in lost time and money as well as further time delays if these issues are not identified and resolved prior to the design and construction of the network. By verifying the address data from data collected from autonomous mobile data collection devices, the field of technology related to utility planning is improved.

Service area segments within the geographic area can be defined and prioritized based on constructability and return on investment, for example, using geographic data (e.g., satellite map images). As the geographic data may be out of date, this segmentation may be erroneous as it may not be based on current utility, infrastructure, or city planning changes. As a result, the network design may not be synchronized with the actual circumstances in the geographic area. For example, utility poles that were important elements of the network design may no longer be present or may be loaded to capacity.

Based on the address data and the segmentation, field visits may be performed to determine where to place components of the network, such as aerial strands, microcell wi-fi components, underground conduit, underground vaults, or line-of-sight equipment. This process may be completed manually and can be labor intensive and time consuming but necessary due to the potential changes described above, and is prone to error. In addition, if this process is completed manually, there may not be a way to accurately determine a clear path for the network. For example, there may not be a feasible way to accurately determine line-of-sight from one location to another or how a wireless signal will be received or deflected by obstacles (e.g., buildings, trees, etc.) when being transmitted from a wireless transmitter to a receiving unit.

After the field visits, the design of the network can be reevaluated based on the data obtained from the field visits. This redesign process can add significant delays and, depending on the delay, additional field visits may be required to confirm the data obtained from the previous site visits is still accurate. For example, this redesign process can result in multiple iterations of redesigns and field visits in areas with high rates of development and infrastructure changes.

After a design of the network has been completed, a determination may be made as to what buildings, utility poles, fiber hut areas, and other infrastructure should be accessed or acquired (e.g., leased or purchased) to deploy/construct the network. This process can include negotiations of agreements that may be time consuming (e.g., taking 3-6 months to complete). If negotiations fail, the network may need to be redesigned resulting in additional field visits, redesigns, and negotiations. Thus, this process of field data collection, field visits, redesigns, and negotiations can be inefficient, time consuming, and error prone.

The use of autonomous mobile data collection devices and machine learning techniques described herein can accelerate the network design process and result in more accurate network designs that perform better than networks designed using the above process. In general, one or more autonomous mobile data collection devices may be deployed to a geographic area in which a network may be installed. The mobile data collection devices can include autonomous or semi-autonomous aerial vehicles (e.g., drones) and/or satellites. The mobile data collection devices can use one or more sensors to collect data for verification of address assignments and physical structures that are believed to be present in the geographic area.

The mobile data collection devices can provide the data collected to a processing system in data communication with the devices to perform the comparison. Alternatively, the autonomous mobile data collection devices may perform the analysis on-board. For example, the mobile data collection devices may compare data regarding physical structures in the geographic area to address data that specifies the types of physical structures (e.g., single family houses, commercial buildings, etc.) that are listed as being at various addresses in the geographic area. If the physical structure that is actually at a particular address does not match the type of physical structure listed at the particular address in the address data, the mobile data collection devices can further investigate the physical structure to identify the physical structure, its dimensions, and other characteristics of the physical structure, as described below.

The mobile data collection devices can also identify and generate a map of existing network infrastructure located in the geographic area. Alternatively, the mobile data collection devices can provide the data collected to a processing system in data communication with the devices to generate the map. For example, the mobile data collection devices may identify and map locations of utility poles, underground network vaults, aerial strands, etc. The mobile data collection devices can also identify components installed on the existing infrastructure, e.g., components installed on utility poles, and the owners of the infrastructure, e.g., based on identification data installed on the infrastructure. For example, the mobile data collection devices may identify the number of components installed on each utility pole that the devices find in the geographic area.

The mobile data collection devices can also collect data for use in generating a model, e.g., a three dimensional model, that depicts a visualization of the geographic area. For example, drones can use lidar sensors to generate a three dimensional virtual cloud that depicts the external surface of physical structures located in the geographic area. The verified address data obtained by the drones can be combined with the model. For example, the model may specify deviations in the address data from the data collected by the mobile data collection devices and the address data.

One or more machine learning model(s) can be used to prioritize segments of the geographic area and/or to generate a network layout based on the model, verified address data, the map of existing infrastructure, and/or additional data collected from one or more other sources. For example, machine learning models may be trained to prioritize segments of the geographic area and/or generate a network layout based on certain features included in this data, such as existing utility providers in the geographic area, building and user density in the various segments of the geographic area, characteristics of physical utility paths in the geographic area (e.g., utility poles in the geographic area, underground access in the geographic area, and/or buildings in the geographic area), clearance of the physical paths (e.g., obstacles, constraints, distance, line of sight between objects, etc.), site acquisition agreements, and/or other appropriate features. A utility network designer can use one or more network layouts generated by the machine learning model to more quickly initiate the construction and implementation of the network.

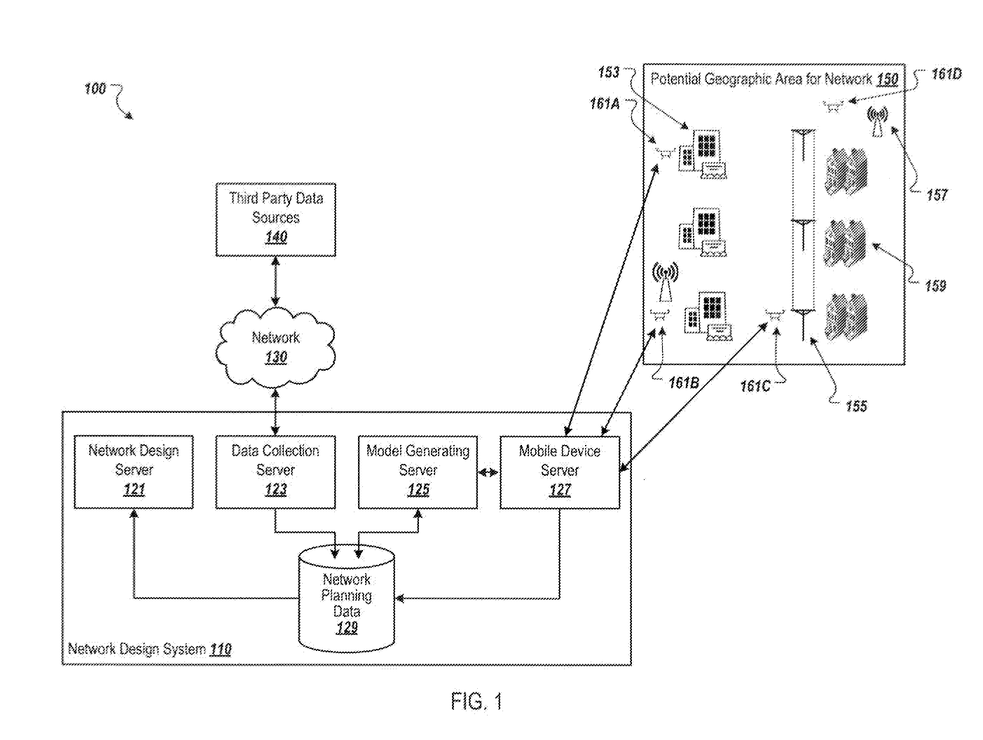

FIG. 1 is an example environment 100 in which a network design system 110 generates a layout of a utility network using mobile data collection devices 161 and machine learning techniques. The network design system 110 includes a network design server 121, a data collection server 123, a model generating server 125, a mobile device server 127, and a network planning data storage device 129. Although the network design system 110 is illustrated as having one of each server and data storage device, the network design system 110 can include multiple of each server and/or data storage device, or the functionality of multiple ones of the servers can be performed by a single server.

The network design server 121 can generate one or more layouts of a network based on data collected and/or generated by the data collection server 123, the model generating server 125, and/or the mobile device server 127. For example, the network design server 121 can generate one or more layouts of a network for a geographic area 150 under consideration for a network. The network can be a utility network, such as a wireless and/or wired data communication network, a power network, a telephone network, or another appropriate type of utility network. The layout of the network can specify the location of various network components, e.g., the location of utility poles, underground vaults, buildings, or other infrastructure on which network components can be installed. The layout of the network can also specify the routing of conductors, e.g., data communication cables, power cables, and/or other appropriate wires or conductors, between components. As described in more detail below, the network design server 121 can use a machine learning model to generate the layout(s) of the network.

The data collection server 123 can obtain data related to the geographic area 150, e.g., from one or more third party data sources 140. For example, the data collection server 123 can obtain the data from third party data sources 140 over a network 130. The network 130 can include a local area network (LAN), a wide area network (WAN), the Internet, a mobile network, or a combination thereof. The data can include address data for the geographic area 150, zoning data for the geographic area 150, maps of the geographic area 150, weather data for the geographic area 150, data identifying existing utility providers (e.g., television, Internet, wi-fi, electricity, mobile and/or landline phone service, etc.) in the geographic area 150, infrastructure patterns in the geographic area 150, and/or other appropriate data that can be used to design a layout of a network.

The address data for the geographic area 150 can include a listing of addresses in the geographic area 150 and/or types of structures (e.g., buildings) believed to be located at the listed addresses. For example, the address data may specify, for each address, whether there is a single family home, a multi-family residence (e.g., apartment building), commercial building, industrial facility, hotel, or other appropriate type of building at the address. The data collection server 123 can obtain and aggregate address data from third party address databases, e.g., maintained by government entities, utility providers, and or other appropriate sources.

The zoning data for the geographic area 150 can include data specifying locations of various zones (e.g., residential, commercial, etc.) in the geographic area 150. The data collection server 123 can obtain the zoning data from one or more government databases maintained by government entities in the geographic area 150.

The data collection server 123 can obtain maps and weather data for the geographic area 150 from web sites, databases, or other electronic resources that maintain such data. For example, the data collection server 123 may obtain historical weather data or weather trend data for the geographic area 150 and/or segments of the geographic area 150 from a weather database maintained by a government entity or other weather monitoring entity. The weather data can also include microclimate data for segments of the geographic area 150. The microclimate data for a segment can include data describing the climate of that segment.

The data regarding infrastructure patterns can include data specifying the location of and the amount of bus routes in segments of the geographic area, the amount of foot traffic in segments of the geographic area, the amount of vehicle traffic in segments of the geographic area, and/or other patterns of human movement within the segments of the geographic area 150.

The data collection server 123 can also collect utility data for the geographic area 150. For example, the data collection server 123 can collect data regarding the number of existing wi-fi signals in the geographic area 150 (e.g., via scanning for wi-fi signals) and/or data regarding current bandwidth of data transmissions in the geographic area 150 (e.g., by analyzing the bandwidth of Internet communications).

In some implementations, a network designer or another person may input or provide some or all of the data to the data collection server 123. The data collection server 123 can also automatically obtain the appropriate data based on a specified geographic location, e.g., specified by a user. For example, the data collection server 123 can include instructions that cause the data collection server 123 to crawl particular web sites and other electronic resources for appropriate data based on the specified location. The data collection server 123 can store the obtained data in the network planning data storage device 129. In some implementations, the mobile data collection devices 161 can obtain the data, e.g., from the data collection server 123 and/or from the third party data sources 140 via the network 130. For example, the mobile data collection devices 161 may include a wi-fi transceiver that enables the mobile data collection devices 161 to obtain data from the Internet.

Users can also add data to the network planning data storage device 129 for the network design server 121 to use when generating layouts of a network. For example, users can add data regarding agreements between the entity for which the network is being designed and other utility providers. The agreements can include existing agreements with other utility providers for potential lease/purchase of a network path, existing agreements for other existing utility poles for easy access, existing agreements with property owners for access to existing buildings, and/or potential lease agreements that can be added for network layout optimization or improvement. As described in more detail, the identify of utility providers that have existing agreements with the entity for which the network is being designed can allow the machine learning model to identify infrastructure that may be more feasible or inexpensive to obtain.

The data collection server 125 can filter the obtained data for the geographic area 150. For example, the data collection server 125 can filter out any obtained data that is not related to a physical structure (e.g., building, infrastructure, etc.) located in the geographic area 150 or a characteristic (e.g., weather, or infrastructure patterns) in the geographic area 150. The data collection server 125 can filter the obtained data based on user input that specifies the location of the geographic area 150. For example, the user input may specify the latitudinal and longitudinal coordinates of the geographic area 150, one or more cities in the geographic area 150, one or more counties in the geographic area 150, or other appropriate location data that specifies the location of the geographic area 150.

The mobile device server 127 can receive data from the mobile data collection devices 161 and store the received data in the network planning data storage device 129. The mobile data collection devices 161 can include autonomous or semi-autonomous aerial vehicles (e.g., drones) and/or satellites that obtain data regarding the geographic area 150. For example, a user may deploy one or more drones to the geographic area 150. The drones may be programmed to navigate the geographic area to obtain data and/or to verify data regarding the geographic area and/or segments of the geographic area. The drones can include sensors, e.g., lidar sensors, and image capturing devices to verify and obtain the data. Autonomous aerial vehicles may collect data and make decisions (e.g., to collect additional data or to modify its navigational plan) based on the collected data. Semi-autonomous may send data to another device (e.g., the mobile device server 127) and receive instructions based on the data.

Satellites can use high resolution imaging to identify the types of physical structures (e.g., buildings, utility poles and towers, natural objects such as trees and mountains) located in the geographic area, the location of the physical structures, and/or the number of each type of physical structure location in the geographic area 150. For example, satellite captured images may be used to identify the location of utility poles located in the geographic area.

The aerial vehicles can determine their own navigation plans (e.g., flight route or road route) to verify and obtain the data regarding the geographic area. For example, a drone can use address data for the geographic area 150, distance data (e.g., between points of interest within the geographic area), obstacle avoidance technology (e.g., to avoid flying over people), weather data (e.g., wind speeds, light levels, humidity, required altitude, etc.), and/or other appropriate data to improve or optimize its flight path through the geographic area 150. The aerial vehicles can improve their routes by identifying a set of potential routes and using the address data, distance data, and weather data to determine which route is more efficient. In addition, the aerial vehicles can adjust their routes while collecting data, for example, in response to changes in weather or detecting obstacles.

In some implementations, a user can provide aerial vehicles with geographic boundaries of the geographic location 150. For example, the geographic boundaries may define a geometric shape (e.g., using latitudinal and longitudinal coordinates) around the geographic area 150 from which data is to be verified and/or obtained by the aerial vehicles. The aerial vehicles can determine a navigational plan within the geographic boundaries such that the appropriate data is verified and/or obtained.

When multiple aerial vehicles are deployed to a geographic area 150, each aerial vehicle can be assigned a segment of the geographic area, e.g., using geographic boundaries. For example, four drones 161A-161D are shown obtaining data from the geographic area 150. In another example, some mobile data collection devices 161 may be deployed to gather certain data while others are deployed to gather different data. For example, a drone may be deployed to obtain dimensional data of physical structures using lidar sensors while another drone may be deployed to map the location of utility poles.

The mobile collection devices 161 can verify address data for the geographic area 150. For example, the mobile device server 127 may provide an aerial vehicle with address data that specifies street addresses in the geographic area 150 and, for each street address, the type of physical structure (e.g., single family houses 159, commercial buildings 153, etc.) located at the street address. The mobile device server 127 can also provide the aerial vehicle with data specifying the typical size, shapes, external materials, and/or other characteristics of each type of physical structure. To verify an address, the aerial vehicle can navigate to the address to verify the presence of the address and the presence of a physical structure at the address. For example, an aerial vehicle may use a Global Positioning System (GPS) navigation system to navigate to the address. The aerial vehicle may then use a lidar sensor to obtain the dimensions (e.g., height, length, and width) and shape of the physical structure located at the address and/or a camera to obtain images of the physical structure. The aerial vehicle can compare the dimensions, shape, and images of the physical structure to dimensions, shapes, and images of various types of physical structures to determine the type of physical structure located at the address.

If the dimensions, shape, or images of the physical structure varies by at least a threshold amount from the dimensions, shape, or images of the type of building specified by the address data, the aerial vehicle may determine that the physical structure does not match the type of physical structure specified by the address data. For example, the address data may specify that a building at a particular address is a single family residence. However, an aerial vehicle may determine that the physical structure at the particular address is five stories tall (e.g., about fifty feet tall). In this example, the typical dimensions of a single family residence may be 15-25 feet tall and the threshold may be ten feet. As fifty feet is greater than thirty-five feet (twenty-five foot house plus ten foot threshold, the aerial vehicle may determine that the physical structure is not a house, but a commercial building if the dimensions of the physical structure are within those of commercial buildings.

If the aerial vehicle determines that the physical structure located at the address matches the type of physical structure specified by the address data for that address, the aerial vehicle can store data (and send the data to the mobile device server 127) indicating that the address has been verified. If the aerial vehicle determines that the physical structure located at the address does not match the type of physical structure specified by the address data for that address, the aerial vehicle may further investigate the physical structure to obtain additional data so that the physical structure can be identified accurately. For example, the aerial vehicle may capture additional images from a close range and/or from different angles. The aerial vehicle may also attempt to identify any signage that may have text identifying the physical structure. The aerial vehicle may also provide the additional collected data. The aerial vehicle or the mobile device server 127 may identify the type of physical structure located at the address based on the additional collected data, the dimensions, the shape, and or the images of the physical structure.

If the address no longer has a physical structure (e.g., a building destroyed to build a new building), the aerial vehicle may identify the address as a greenfield area. These greenfield areas can be a good place to build new infrastructure, e.g., during the construction of a new building.

In some implementations, a semi-autonomous aerial vehicle obtains the dimensions, shape, and images of the physical structure and sends this data to the mobile device server 127. The mobile device server 127 may then determine whether the physical structure matches the type of physical structure specified by the address data. If the structures do not match, the mobile device server 127 may cause the semi-autonomous aerial vehicle to collect the additional data for the physical structure. For example, the mobile device server 127 may instruct the aerial device to obtain additional images from specific angles and/or altitude, and/or to identify signage of the physical structure.

The aerial vehicle can obtain data regarding each physical structure in the geographic area. For example, the aerial vehicles can capture images of the physical structures and determine the type of material that is on the exterior of the structures. This material data can be used to determine how well wireless signals can be transmitted art or near the physical structure(s). The aerial vehicles may also identify the owner of the buildings, e.g., by identifying a sign on the building and using optical character recognition (OCR) to recognize the text of the sign.

The mobile data collection devices 161 can also identify the location of network infrastructure located in the geographic area 150. For example, aerial vehicles may search for utility poles 155, aerial strands, satellite dishes, vaults, substations, cell towers 157, power plants, and/or other visible infrastructure and record the type and location of each identified piece of infrastructure. The mobile data collection devices 161 can also identify components installed on the existing infrastructure, e.g., components installed on utility poles, and the owners of the infrastructure, e.g., based on identification data installed on the infrastructure. For example, the mobile data collection devices 161 may identify and record the number of components installed on each utility pole found in the geographic area.

The aerial vehicles can identify the owner of a utility pole or other infrastructure component by identifying a tag or label attached to the component. For example, some utility poles include a tag that identifies the owner. The aerial vehicles can capture and image of the tag and use OCR to recognize the text depicted on the tag. If a tag is not found on the infrastructure component, the aerial vehicle may identify the owner based on the known owner of other infrastructure in the geographic area. For example, an aerial vehicle may identify another utility pole that has one or more conductors connected to a utility pole that does not have a tag. The aerial vehicle may navigate to the other utility pole to determine if that utility pole has a tag. In another example, the aerial vehicle may determine the owner based on knowledge that the owner has other utility poles near that utility pole (e.g., within a threshold distance) and that there are no other utility pole owners in the area, e.g., from data gathered by the data collection server 123.

The mobile device server 127 may also use satellite images to determine the location of infrastructure. For example, the mobile device server 127 may use object recognition to identify utility poles, aerial strands, satellite dishes, and other components depicted in the satellite images.

The mobile device server 127 (or the aerial vehicles themselves) can generate a map of the infrastructure. The map can include, for each infrastructure component, data specifying the type of component (e.g., utility pole or satellite dish), the owner (if known or determined) of the component, the loading (e.g., how many components installed on a utility pole and the amount of availability the pole has) of the component, and/or other appropriate data regarding the infrastructure component.

Aerial vehicles can use lidar sensors to scan the geographic area 150 for data regarding the location and dimensions of the physical objects (e.g., buildings, utility poles, natural objects, etc.) located in the geographic area 150. The aerial vehicles can provide the data to the mobile device server 127 which, in turn, provides the data to the model generating server 125. The model generating server 125 can generate a three dimensional model of the geographic area 150 that depicts a real-time visualization of the geographic area 150 with millimeter accuracy. The model generating server 125 can combine this three dimensional model with the verified address data and/or the utility map data to generate a three dimensional virtual cloud for the geographic area 150. For example, the three dimensional virtual cloud may specify deviations (e.g., deviations in structure types) in the address data and the data obtained by the mobile data collection devices 161. In some implementations, the aerial vehicles generate the three dimensional model and the three dimensional virtual cloud using the data from the lidar sensors and/or data received from the mobile device server 127.

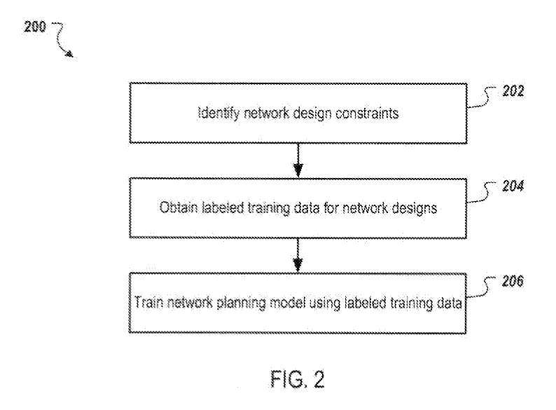

The network design server 121 can train and use a network planning model, e.g., a machine learning model, to generate one or more layouts of a utility network based on the data obtained by the data collection server 123, the mobile device server 127, and or from one or more users. For example, the network design server may apply a network planning model to the three dimensional virtual cloud generated by the model generating server 125. The network planning model may output one or more layouts of a network for the geographic area 150. An example process for training the model is illustrated in FIG. 2 and described below.

As described above, the layout of the network can specify the location of various network components and the routing of conductors. For example, the layout may specify which utility poles, buildings, or other infrastructure on which particular network components should be installed. If infrastructure components are not owned by the entity for which the layout was generated, the entity can begin the process of acquiring the infrastructure or space on the infrastructure at this point without having to make several costly trips to the geographic area to reconfirm the accuracy of the data.

The network planning model can generate one or more layouts of the network based on requirements of the network and/or components thereof (e.g., maximum cable distances, maximum wireless distances, etc.) a physical path analysis of the data obtained by the data collection server 123 and the mobile device server 127, a physical path clearance analysis of the data, and/or data regarding site acquisition agreements for infrastructure located in the geographic area 150. The physical path analysis can be based on data regarding utility poles in the geographic area 150, data regarding underground access in the geographic area 150, data regarding buildings located in the geographic area 150, and/or similar data for other types of infrastructure located in the geographic area 150.

The data regarding utility poles in the geographic area 150 can include national, regional, and/or local codes, requirements, or best practices. For example, such requirements may limit the number of components installed on a utility pole. The data regarding utility poles can also include data regarding existing utility poles in the geographic area, such as the existing load of the poles, location of the poles, ownership of the poles, requirements of the pole owners, whether rework would be needed for the poles (e.g., if components would need to be moved to accommodate new components), and/or whether one touch make ready agreements exist for the poles or pole owners. This data can be used by the network planning model to identify poles where components of the network may be installed. The network planning model can user pole loading data and pole ownership data to determine which poles would be more feasible to install components of the network. For example, a utility pole that is at or near capacity may be unavailable or may be very expensive due to rework needed. Similarly, utility poles that have capacity and that are owned by entities with which the utility provider designing the network has existing agreements may be more feasible and less expensive than those that are near capacity or owned by others. The network planning model can use similar data for other types of infrastructure, such as underground vaults, buildings on which infrastructure can be installed, etc.

The data regarding underground access in the geographic area 150 can include data identifying the edges of pavement and broadband pedestals (e.g., from data obtained by the mobile data collection devices 161), features of the geographic area 150 that may impact trenching lines, and/or elements that may impact construction methods, such as trenching, boring, drilling, or other construction methods. The network planning model can use this data to identify paths to route conductors underground and to determine which of the paths are more feasible, less expensive, or that would require the least amount of work.

The data regarding buildings located in the geographic area 150 can include national, regional, and/or local codes, requirements, or best practices, building data (e.g., size, use, etc.), external composites (e.g., martial, siding, roof, etc.), building owner stipulations and requirements, and/or future building access regulations for installation and future operations and maintenance. The network planning model can use this data to identify buildings on which network components can be installed and the relative feasibility of the buildings for installing the network components. In addition, the network planning model can use the external composites data to assess the performance of wireless data transmissions at or near the buildings.

The physical path clearance analysis can be based on data regarding the clearance of wired and wireless paths. The data regarding the clearance of wired paths can include data identifying physical constraints (e.g., crossing roads, cable budget constraints, etc.) and data identifying obstacles in wired paths (e.g., trees, buildings, etc.). The data regarding the clearance of wired paths can include distance between potential locations of transceivers, line of sight between potential locations of transceivers, and/or data regarding invisible obstacles (e.g., external environment, weather, heat factors, smog, emissions, etc.). The network planning model can use this data to assess the relative feasibility and performance of potential wired and wireless paths for the network. For example, the network planning model may determine that a wired path would be more feasible and result in better network performance for a particular portion of the network due to the amount of invisible obstacles in the area where the particular portion of the network would be installed.

The data regarding site acquisition agreements for infrastructure located in the geographic area 150 can include data included in existing agreements with other utility providers for the potential acquisition (e.g., purchase or lease) of a network path, existing agreements for other existing poles for efficient access, existing agreements with property owners for other existing buildings, and/or potential lease agreement that can be added for route improvement. The network planning model can use this date to assess the relative ability to acquire infrastructure assets on which network components can be installed. For example, if the utility provide has existing agreements with a pole owner, it may be easier, cheaper, and less time consuming to acquire space on the poles of this pole owner than space on poles of pole owners with which the utility provider does not have existing agreements.

The network design server 121 can also train and use a machine learning model to prioritize segments within a geographic area 150 for installing a network. For example, a utility provider may determine that it only wants to install a network in certain segments of the geographic area 150, but not all of the geographic area 150. The machine learning model may be trained to define and prioritize segments based on commercial data, such as historical, statistical consumer take-rate/adoption data. For example, the machine learning model may define and prioritize the segments based on correlations between the historical, statistical consumer take-rate/adoption data and the presence in each segment of one or more of existing utility providers, user density, building density, types of buildings, businesses, and services, infrastructure patterns (e.g., bus routes, foot traffic, cars, etc.), microclimates, utility usage information, and current utility access information (e.g., number of existing wi-fe signals, existing utility infrastructure, or current bandwidth). Using this data and/or other data obtained by the data collection server 123 and the mobile device server 127, the machine learning model can define and prioritize segments that are more likely to result in higher take-rates for the utility provided by the utility provider.

FIG. 2 is a flow chart of an example process 200 for training a network planning model to generate a layout of a utility network. Operations of the process 200 can be implemented, for example, by a system that includes one or more data processing apparatus, such as the network design server 121 of FIG. 1. The process 200 can also be implemented by instructions stored on computer storage medium, where execution of the instructions by a system that includes a data processing apparatus cause the data processing apparatus to perform the operations of the process 200.

The system identifies network designs constraints for a utility network (202). The network design constraints may specify physical and/or performance constraints of components that can be used to implement the utility network. For example, a physical constraint for a wireless transceiver may specify a minimum height at which the transceiver must be installed. An example of a performance constraint is a maximum distance for a network cable or wireless signal, e.g., before a repeater or extender is necessary. Performance constraints can also include data specifying the relative performance of a component in various environments, e.g., a wireless transceiver may have higher performance when placed closer to another wireless transceiver. This constraints data allows the network planning model to properly place components in appropriate locations and in a way that improves the performance of the network.

The system obtains labeled training data for layouts of networks (204). For example, the system may obtain the labeled training data from a database of training data. The labeled training data for each layout can include feature values for a set of features of the layout and a label specifying a rating of the layout. For example, the rating may be based on the performance of the network, the cost of the network, the efficiency of the network, the amount of time taken to install the network, and/or the amount of time taken to finalize the network design (e.g., including time to negotiate acquisition agreements for network infrastructure). In some implementations, the rating may be specified by a user, e.g., a network designer.

The set of features can be based on the types of data obtained by the data collection server 123 and the mobile device server 127, and the data input by users, as described above. For example, the features may include features related to utility poles, existing network infrastructure, data used in physical path analyses (e.g., data regarding utility poles, underground access, and buildings), data used in physical path clearance analyses for wired and wireless networks, and/or data included in site acquisition agreements. In particular, a feature may be the presence of an obstacle (e.g., one or more trees) between buildings or potential locations of utility poles. Another feature may be the owner of a utility pole.

The system trains a network planning model (e.g., machine learning model) to generate layouts of a network using the labeled training data (206). In some implementations, the system may generate the network planning model by partitioning a portion of the layouts and the corresponding feature values and labels into a training set and a testing set. The network planning model may then be trained using the feature values for each layout in the training set and the labels for each layout in the training set. In some implementations, the network planning model may include one or more weights associated with particular features of the layouts in the training set. Training the network planning model may include adjusting the weights associated with the features and feature combinations that are found to be predictive of the rating of the layouts. Various methods and techniques for correlating the features and the labels may be used, such as clustering, linear regression, logistic regression, and non-linear regression.

After training the network planning model, the model may then be tested using the layouts and labels in the testing set or in another training set. The weights associated with each feature in the network planning model may then be adjusted based on the results of the testing. A similar process may be used to train a network planning model to prioritize segments of a geographic area. For example, labeled training data for this model may include a set of layouts of networks, feature values for features of segments of the layouts, and labels for each segment. The labels for a segment may be based on the relative priority of the segment with respect to other segments. For example, the labels may have a value between one and ten, where a segment with a label having a value of ten may be a highest priority segment and a segment with a label having a value of one is a lowest priority segment. The features may include features related to the historical, statistical consumer take-rate/adoption data for the segments in the training set and the presence in these segments of existing utility providers, user density, building density, types of buildings, businesses, and services, infrastructure patterns, microclimates, utility usage information, and/or current utility access information.

The system can train the network planning model by partitioning a portion of the segments into a training set and a testing set. The network planning model may then be trained using the feature values for each segment in the training set and the labels for each layout in the training set. After training the network planning model, the model may then be tested using the segments and labels in the testing set or in another training set. The weights associated with each feature in the network planning model may then be adjusted based on the results of the testing.

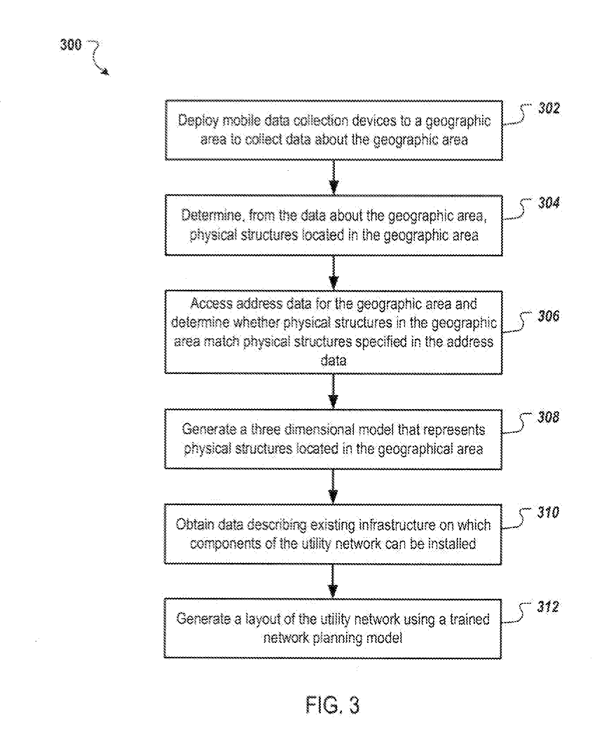

FIG. 3 is a flow chart of an example process 300 for generating a layout of a utility network. Operations of the process 300 can be implemented, for example, by a system that includes one or more data processing apparatus, such as the network design server 121 of FIG. 1. The process 300 can also be implemented by instructions stored on computer storage medium, where execution of the instructions by a system that includes a data processing apparatus cause the data processing apparatus to perform the operations of the process 300.

The system deploys one or more mobile data collection devices to a geographic area to collect data about the geographic area (302). For example, the mobile data collection devices may include one or more autonomous or semi-autonomous aerial vehicles. The system may provide the aerial vehicles with data identifying the location of the geographic area. For example, the system may provide data specifying geographic boundaries in which the aerial vehicles are to obtain and/or verify data. The system may also provide to the aerial vehicles information specifying the data that the aerial vehicles are to obtain, e.g., address data, locations of infrastructure, images of infrastructure and other physical structures, etc.

The mobile data collection devices can navigate the geographic area to collect the data. In some implementations, the mobile data collection devices can generate and adjust their own navigation plans, e.g., based on distance data, obstacle avoidance technology, weather data, road maps, traffic data, etc. The mobile data collection devices can use the navigational plans to navigate the geographic area.

The system determines physical structures located in the geographic area (304). For example, the mobile data collection devices may use lidar sensors to obtain the dimensions and shapes of physical structures located at various addresses in the geographic area. The mobile data collection devices may also use a camera to capture images of the physical structures. Based on the obtained data, the mobile data collection devices, or a server in communication with the mobile data collection devices, may determine the type of physical structure located at each address. For example, the mobile data collection devices may compare the dimensions, shapes, and/or images to corresponding dimensions, shapes, and/or images of various types of physical structures to determine the type of physical structure at each address. In another example, the system may use computer vision techniques to extract information from the images and determine the type of physical structure depicted in the image. For example, the system may use object recognition techniques to detect objects that are present on various types of physical structures.

The system accesses address data and determines whether physical structures located in the geographic area match physical structures specified in the address data (306). For example, the system may compare the type of physical structure determined by the mobile data collection devices for an address to the type of physical structure specified by the address data for the address. In another example, the system may compare the dimensions, shape, and/or images obtained by the mobile data collection devices to dimensions, shapes, and/or images of various types of physical structures to determine whether the physical structure at the address matches the type of physical structure specified by the address data.

The system generates a three dimensional model that represents physical structures located in the geographic area (308). For example, the system may generate the three dimensional model based on data received from the lidar sensors. The three dimensional model can depict a real-time visualization of the geographic area 150 with millimeter accuracy. The three dimensional model can also specify deviations between the address data and the physical structures identified by the mobile data collection devices. For example, the three dimensional model may specify deviations between types of buildings determined by the mobile data collection devices and types of buildings specified by the address data.

The system obtains data describing existing infrastructure on which components of the utility network can be installed (310). For example, the system may obtain the data from the mobile data collection devices, third party data sources, and/or users. As described above, the data can include a map of the infrastructure located in the geographic area, data identifying existing utility providers in the geographic area, data regarding utility poles in the geographic area, data regarding underground access in the geographic area, data regarding buildings in the geographic area, data regarding wired and wireless path clearances, site acquisition agreements, and/or other appropriate data regarding infrastructure or potential places to install infrastructure in the geographic area.

The system generates one or more layouts of the utility network using a trained network planning model (312). For example, the network planning model may be trained using the process 200 illustrated in FIG. 2 and described above. The network planning model may identify potential locations for installing network components based on the three dimensional model and the data describing the existing infrastructure. For example, the network planning model may identify existing utility poles and buildings on which additional network components can be installed. The network planning model may then use the three dimensional model and/or a map of the existing infrastructure to identify potential paths between the potential locations to complete the network. The paths can include wired and wireless paths, for example, if the network is a data communication network.

The network planning model may then evaluate the potential paths to identify one or more layouts for the network. To do this, the network planning model may identify feature values for various features of the network. For example, a utility pole may have several features, such as a feature for its owner, a feature for is capacity for additional components, a feature for its location, etc. The network planning model may assign feature values to each of these features based on the data obtained for the utility pole. For example, the network planning model may assign a feature value of ten to the utility pole if the pole has a particular amount of capacity or a feature value of zero if the pole has no capacity. The network planning model can assign feature values for each feature that the network planning model was trained to consider. The features used by the network planning model can include features related to any of the data described above obtained by the data collection server 123, the mobile device server 127, and users.

As described above, the network planning model can also perform a physical path analysis of the data obtained by the data collection server 125 and the mobile device server 127, a physical path clearance analysis of the data, and/or data regarding site acquisition agreements for infrastructure located in the geographic area. The network planning model can identify feature values for features related to these analyses. For example, the network planning model may assign the feature of a particular path between two locations a feature value based on obstacles identified in the path. In this example, the network planning model may use the three dimensional model to identify the obstacles (e.g., trees, buildings, external surfaces of buildings, etc.) between the two locations and determine the feature value based on the identified obstacles.

The network planning model may then rank potential layouts based on an overall score for each layout. The overall score for a particular layout of the network may be based on a combination of the feature values of the features of the layout and weights assigned to each feature. For example, the network planning model may determine, for each feature, a product of the feature value for the feature and the weight for the feature. The network planning model may then determine the sum of the feature values for the particular layout as the overall score for the particular layout.

The network planning model may determine the weights during training, as described above. In addition, a network designer may adjust the weights, e.g., to customize the model for various objectives. For example, the network designer may adjust the weights such that wired paths are given zero or low weights such that the network planning model outputs only wireless network layouts, e.g., in areas with high winds or severe storms.

The system may also adjust the weights automatically based on one or more objectives or priorities of the network. An example objective may be to increase performance of the network and another example objective may be to reduce installation time. The weights assigned to the various features may be different based on the objective. For example, pole ownership may be given a low weight if the objective is performance whereas pole ownership may be given a higher weight of reducing installation time is the objective.

The system may output the highest ranked layouts. For example, the system may update a user interface to display the highest ranked layouts. A network designer can then use the layout to initiate the acquisition of infrastructure and the construction of the network.

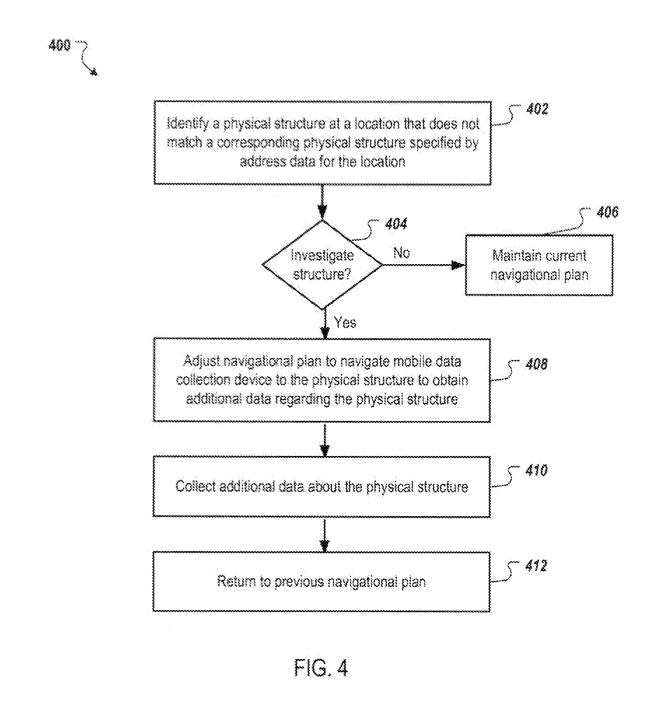

FIG. 4 is a flow chart of an example process 400 for collecting information about a physical structure. Operations of the process 400 can be implemented, for example, by an autonomous aerial vehicle or a semi-autonomous aerial vehicle.

The aerial vehicle identifies a physical structure at a location that does not match a corresponding physical structure specified by address data for the location (402). For example, the aerial vehicle may be following a navigational plan to verify address data for a geographical area. The aerial vehicle may determine the type of physical structure (e.g., single family house, commercial building, etc.) at an address and compare the determined type to the type of physical structure that is listed in the address data for the address. As described above, the aerial vehicle may determine the type of physical structure for an address by comparing dimensions, shape, and images of the physical structure to dimensions, shapes, and images of the various types of physical structures.

The aerial vehicle determines whether to further investigate the physical structure (404). For example, the aerial vehicle may determine to further investigate the physical structure automatically if the aerial vehicle determines that the type of physical structure at the location does not match the type specified by the address data for the location.

If the types match, the aerial vehicle may determine to maintain its current navigational plan (406). For example, the aerial vehicle may navigate to the next address to verify the type of physical structure at that address.

If the aerial vehicle determines to further investigate the physical structure, the aerial vehicle may navigate to (e.g., by adjusting its navigational plan) to the physical structure to obtain additional data regarding the physical structure (408). For example, the aerial vehicle may navigate closer to the physical structure and/or around the physical structure.

The aerial vehicle collects additional data about the physical structure (410). For example, the aerial vehicle may capture additional images of the physical structure from multiple different angles. The aerial vehicle may also attempt to identify signs and, if so, may use OCR to recognize the text depicted by the signs. After collecting the additional data, the aerial vehicle can return to its previous navigation plan (412).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for planning a utility network, the system comprising:
a set of autonomous mobile data collection devices for deploying to a geographic area to collect data about the geographic area; and
a data processing apparatus installed on or in data communication with the autonomous data collection devices, and that performs operations comprising:
determining, from the data about the geographic area, physical structures located in the geographic area;
accessing address data for the geographic area, the address data specifying physical structures and locations of the physical structures, and determining whether physical structures located in the geographic area match physical structures specified in the address data for the geographic area;
generating, from the data about the geographic area, a three dimensional model that represents the physical structures located in the geographical area, wherein the three dimensional model specifies deviations in the address data from the data about the geographic area collected from the autonomous mobile data collection devices;
obtaining, at least from the data about the geographic area, data describing existing infrastructure on which components of the utility network can be installed; and
generating, based on the three dimensional model and the data describing the existing infrastructure, a layout of the utility network using a trained network planning model.

2. The system of claim 1, wherein the autonomous mobile data collection devices comprise autonomous aerial vehicles.

3. The system of claim 1, wherein the operations comprise:
identifying, from the data collected by the autonomous mobile data collection devices, a particular physical structure located at a particular location within the geographic area that does not match a corresponding physical structure specified by the address data for the particular location; and
adjusting a navigational plan of the autonomous mobile data collection devices to navigate to the particular physical structure to obtain additional information regarding the particular physical structure.

4. The system of claim 1, wherein the network planning model generates the layout of the utility network based one or more objectives for the utility network and weights assigned to each feature of a set of features, the features including at least one of (i) characteristics of objects located along physical paths along which the network can be routed, (ii) characteristics of clearance to route wires or transmit wireless signals along the physical paths, (iii) data related to existing agreements between an owner of the network and other utility providers or property owners in the geographic area, or (iv) weather data for the geographic area.

5. The system of claim 1, wherein the data about the geographic area comprises dimensions of the physical structures located in the geographical area and a map of one or more existing utility networks in the geographic area.

6. The system of claim 1, wherein the data describing the existing infrastructure comprises data identifying one or more utility poles located in the geographic area, including at least one of an owner of the one or more utility poles or components installed on the one or more utility poles.

7. The system of claim 1, wherein the data about the geographic area comprises data describing one or more buildings located in the geographic area, including dimensions of the one or more buildings, external material of the one or more buildings, or an owner of the one or more buildings.

8. The system of claim 1, wherein the operations comprise obtaining data describing infrastructure located in the geographic area from one or more third party data sources.

9. A method for planning a utility network, comprising:
deploying autonomous mobile data collection devices to a geographic area and causing the autonomous mobile data collection devices to collect data about the geographic area;
determining, from the data about the geographic area, physical structures located in the geographic area;
accessing address data for the geographic area, the address data specifying physical structures and locations of the physical structures, and determining whether physical structures located in the geographic area match physical structures specified in the address data for the geographic area;
generating, from the data about the geographic area, a three dimensional model that represents the physical structures located in the geographical area, wherein the three dimensional model specifies deviations in the address data from the data about the geographic area collected from the autonomous mobile data collection devices;
obtaining, at least from the data about the geographic area, data describing existing infrastructure on which components of the utility network can be installed; and
generating, based on the three dimensional model and the data describing the existing infrastructure, a layout of the utility network using a trained network planning model.

10. The method of claim 9, wherein the autonomous mobile data collection devices comprise autonomous aerial vehicles.

11. The method of claim 9, further comprising:
identifying, from the data collected by the autonomous mobile data collection devices, a particular physical structure located at a particular location within the geographic area that does not match a corresponding physical structure specified by the address data for the particular location; and
adjusting a navigational plan of the autonomous mobile data collection devices to navigate to the particular physical structure to obtain additional information regarding the particular physical structure.

12. The method of claim 9, wherein the network planning model generates the layout of the utility network based one or more objectives for the utility network and weights assigned to each feature of a set of features, the features including at least one of (i) characteristics of objects located along physical paths along which the network can be routed, (ii) characteristics of clearance to route wires or transmit wireless signals along the physical paths, (iii) data related to existing agreements between an owner of the network and other utility providers or property owners in the geographic area, or (iv) weather data for the geographic area.

13. The method of claim 9, wherein the data about the geographic area comprises dimensions of the physical structures located in the geographical area and a map of one or more existing utility networks in the geographic area.

14. The method of claim 9, wherein the data describing the existing infrastructure comprises data identifying one or more utility poles located in the geographic area, including at least one of an owner of the one or more utility poles or components installed on the one or more utility poles.

15. The method of claim 9, wherein the data about the geographic area comprises data describing one or more buildings located in the geographic area, including dimensions of the one or more buildings, external material of the one or more buildings, or an owner of the one or more buildings.

16. The method of claim 9, further comprising obtaining data describing infrastructure located in the geographic area from one or more third party data sources.

17. A non-transitory computer storage medium encoded with a computer program, the program comprising instructions that when executed by data processing apparatus cause the data processing apparatus to perform operations comprising:
receiving, from autonomous mobile data collection devices deployed to a geographic area, data about the geographic area collected by the autonomous data collection devices;
determining, from the data about the geographic area, physical structures located in the geographic area;
accessing address data for the geographic area, the address data specifying physical structures and locations of the physical structures, and determining whether physical structures located in the geographic area match physical structures specified in the address data for the geographic area;
generating, from the data about the geographic area, a three dimensional model that represents the physical structures located in the geographical area, wherein the three dimensional model specifies deviations in the address data from the data about the geographic area collected from the autonomous mobile data collection devices;
obtaining, at least from the data about the geographic area, data describing existing infrastructure on which components of the utility network can be installed; and
generating, based on the three dimensional model and the data describing the existing infrastructure, a layout of the utility network using a trained network planning model.

18. The non-transitory computer storage medium of claim 17, wherein the autonomous mobile data collection devices comprise autonomous aerial vehicles.

19. The non-transitory computer storage medium of claim 17, wherein the operations comprise:
identifying, from the data collected by the autonomous mobile data collection devices, a particular physical structure located at a particular location within the geographic area that does not match a corresponding physical structure specified by the address data for the particular location; and
adjusting a navigational plan of the autonomous mobile data collection devices to navigate to the particular physical structure to obtain additional information regarding the particular physical structure.

20. The non-transitory computer storage medium of claim 17, wherein the network planning model generates the layout of the utility network based one or more objectives for the utility network and weights assigned to each feature of a set of features, the features including at least one of (i) characteristics of objects located along physical paths along which the network can be routed, (ii) characteristics of clearance to route wires or transmit wireless signals along the physical paths, (iii) data related to existing agreements between an owner of the network and other utility providers or property owners in the geographic area, or (iv) weather data for the geographic area.
